(19) United States
(12) Patent Application Publication
(10) Pub. No.: US 2022/0189033 A1
(43) Pub. Date: Jun. 16, 2022

(54) BOUNDARY DETECTION DEVICE AND METHOD THEREOF

(71) Applicant: ULSee Inc., Taipei City (TW)

(72) Inventor: Yi-Ta WU, Taipei City (TW)

(73) Assignee: ULSee Inc., Taipei City (TW)

(21) Appl. No.: 17/117,423

(22) Filed: Dec. 10, 2020

(51) Int. Cl. G06T 7/13; G06T 7/40; G06T 5/00; G06T 7/73; B64C 39/02; B64D 47/08; A01D 34/00

(52) U.S. Cl. CPC G06T 7/13; G06T 7/40; G06T 5/002; G06T 7/74; B64C 39/024; G05D 1/0212; A01D 34/008; G06T 2207/10032; G06T 2207/10024; G06T 2207/20192; B64C 2201/127; B64D 47/08

(57) ABSTRACT

A boundary detection device is provided in the present invention. The boundary detection device includes a camera drone and an image processing unit. The camera drone, for shooting a region to obtain an aerial image data. The image processing unit is configured to convert the aerial image data from a RGB color space to an XYZ color space, then convert the aerial image data from the XYZ color space to a Lab color space to obtain a Lab color image data, and then operate a brightness feature data and a color feature data according to the Lab color image data. The image processing unit picks first to eighth circular masks, each of the circular masks having a boundary line to divide the mask region into two left and right semicircles with different colors.

### FIELD OF THE INVENTION

The present invention relates to the technical field of image recognition technology, in particular, to a boundary detection device and method thereof.

### BACKGROUND OF THE INVENTION

In the image recognition technology with computers, the recognition for the boundary and contour of an image is quite basic and important; for example, how to clearly define the boundaries and contours from the images for the computer to determine the working range of a machine is important, such as how the robotic arm pick up items at a fixed point, and how the lawn mower determine the range of mowing. Therefore, the inventor thinks how to improve the quality for the boundary detection and recognition of the image is very important, thus thinking about ways to improve.

### SUMMARY OF THE INVENTION

The problem solved by the present invention is to improve the boundary detection and recognition of the image and other related problems.

According to a first embodiment, a boundary detection device is provided in the present invention. The boundary detection device includes a camera drone and an image processing unit. The camera drone, for shooting a region to obtain an aerial image data. The image processing unit, communicatively connected to the camera drone, wherein the image processing unit is configured to convert the aerial image data from a RGB color space to an XYZ color space according to a formula

$$[ \begin{matrix}X \\ Y \\ Z\end{matrix} ] = [ \begin{matrix}0.4124 & 0.3575 & 0.1804 \\ 0.2126 & 0.7151 & 0 .0721 \\ 0.0193 & 0.1191 & 0.9502\end{matrix} ] [ \begin{matrix}R \\ G \\ B\end{matrix} ] ,$$

then convert the aerial image data from the XYZ color space to a Lab color space according to a formula:

$$L = \{ \begin{matrix}116 * {( \frac{Y}{{Y}_{n}} )}^{\frac{1}{3}} - 16 , if \frac{Y}{{Y}_{n}} > 0.008856 \\ 9.03 .3 * \frac{Y}{{Y}_{n}} , others\end{matrix} \\ a = 500 * ( f ( \frac{X}{{X}_{n}} ) - f ( \frac{Y}{{Y}_{n}} ) ) b = 200 * ( f ( \frac{Y}{{Y}_{n}} ) - f ( \frac{Z}{{Z}_{n}} ) ) wherein \\ {X}_{n} = 0.9 \; 515 {Y}_{n} = 1.0000 {Z}_{n} = 1.0886 , \\ f ( t ) = \{ \begin{matrix}{t}^{\frac{1}{3}} , if t > 0.0 \; 08856 \\ 7.787 * t + \frac{16}{116} , others\end{matrix}$$

to obtain a Lab color image data, and then operate a brightness feature data and a color feature data according to the Lab color image data; then, the image processing unit picks first to eighth circular masks, each of the circular masks having a boundary line to divide the mask region into two left and right semicircles with different colors, and boundary lines of the first to eighth circular masks are separated from a boundary line of the first circular shield by 22.5° clockwise in sequence. The image processing unit employs the first to eighth circular masks to perform a light and shadow intensity operation on each image point in the Lab color image data to obtain a texture feature data. The image processing unit performs operations according to the brightness feature data, the color feature data, and the texture feature data to obtain a first image boundary contour data.

According to a second embodiment, a boundary detection method is provided in the present invention. The method includes steps of:

(1) shooting a region to obtain an aerial image data with a camera drone, and sending the aerial image data to an image processing unit;

(2) converting, with the image processing unit, the aerial image data from a RGB color space to an XYZ color space according to a formula

$$[ \begin{matrix}X \\ Y \\ Z\end{matrix} ] = [ \begin{matrix}0.4124 & 0.3575 & 0.1804 \\ 0.2126 & 0.7151 & 0.0 \; 721 \\ 0.0193 & 0.1191 & 0.9502\end{matrix} ] [ \begin{matrix}R \\ G \\ B\end{matrix} ] ,$$

then convert the aerial image data from the XYZ color space to a Lab color space according to a formula:

$$L = \{ \begin{matrix}116 * {( \frac{Y}{{Y}_{n}} )}^{\frac{1}{3}} - 16 , if \frac{Y}{{Y}_{n}} > 0.008856 \\ 9.03 .3 * \frac{Y}{{Y}_{n}} , others\end{matrix} \\ a = 500 * ( f ( \frac{X}{{X}_{n}} ) - f ( \frac{Y}{{Y}_{n}} ) ) b = 200 * ( f ( \frac{Y}{{Y}_{n}} ) - f ( \frac{Z}{{Z}_{n}} ) ) wherein \\ {X}_{n} = 0.9 \; 515 {Y}_{n} = 1.0000 {Z}_{n} = 1.0886 \\ f ( t ) = \{ \begin{matrix}{t}^{\frac{1}{3}} , if t > 0.0 \; 08856 \\ 7.787 * t + \frac{16}{116} , others\end{matrix} ;$$

(3) operating, with the image processing unit, a brightness feature data and a color feature data according to the Lab color image data;

(4) picking, with the image processing unit, first to eighth circular masks, each of the circular masks having a boundary line to divide the mask region into two left and right semicircles with different colors, wherein boundary lines of the first to eighth circular masks are separated from a boundary line of the first circular shield by 22.5° clockwise in sequence; employing, with the image processing unit, the first to eighth circular masks to perform a light and shadow intensity operation on each image point in the Lab color image data to obtain a texture feature data;

(5) performing, with the image processing unit, operations according to the brightness feature data, the color feature data, and the texture feature data to obtain a first image boundary contour data.

Compared with the prior art, the present invention has the following creative features:

Eight circular masks having boundary lines with different angles are used to perform light and shadow intensity operations on each image point, so that when operations are performed for the image data according to the brightness feature data, the color feature data, and the texture feature data to obtain a first image boundary contour data, the first image boundary contour data has a better contour curve and hence is closer to a boundary contour of a real image. In particular, when the image is subjected to multilevel thresholding for contour analysis, the present invention may get a better contour analysis effect, so as to improve the quality of the overall boundary detection and contour recognition of the image.

### BRIEF DESCRIPTION OF THE DRAWINGS

FIG. 1 is a view showing a connection of various components of the present invention;

FIG. 2 is a flow chart of steps of the present invention;

FIG. 3 is a view of each mask;

FIG. 4 is a view showing a spiral motion path.

### DETAIL DESCRIPTIONS

In order to make the purpose and advantages of the invention clearer, the invention will be further described below in conjunction with the embodiments. It should be understood that the specific embodiments described here are only used to explain the invention, and are not used to limit the invention.

It should be understood that in the description of the invention, orientations or position relationships indicated by terms upper, lower, front, back, left, right, inside, outside and the like are orientations or position relationships are based on the direction or position relationship shown in the drawings, which is only for ease of description, rather than indicating or implying that the device or element must have a specific orientation, be constructed and operated in a specific orientation, and therefore cannot be understood as a limitation of the invention.

Further, it should also be noted that in the description of the invention, terms “mounting”, “connected” and “connection” should be understood broadly, for example, may be fixed connection and also may be detachable connection or integral connection; may be mechanical connection and also may be electrical connection; and may be direct connection, also may be indirection connection through an intermediary, and also may be communication of interiors of two components. Those skilled in the art may understand the specific meaning of terms in the invention according to specific circumstance.

### Embodiment 1

The present invention is a boundary detection device and method; first, the boundary detection device is described, which includes:

a camera drone 1:

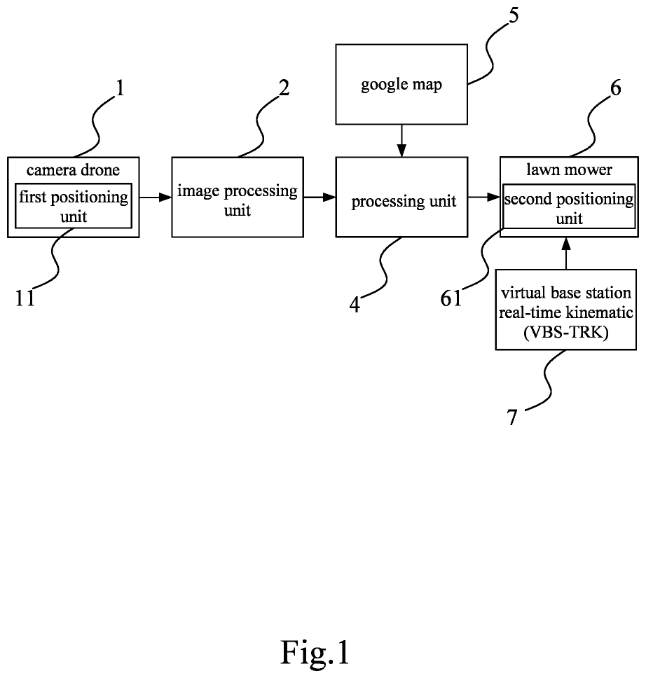

with reference to FIG. 1, the camera drone 1 is configured to shoot a region to obtain an aerial image data; the region may be street scenes, green areas, mountain areas, etc., which are mainly shot according to user needs;

an image processing unit 2:

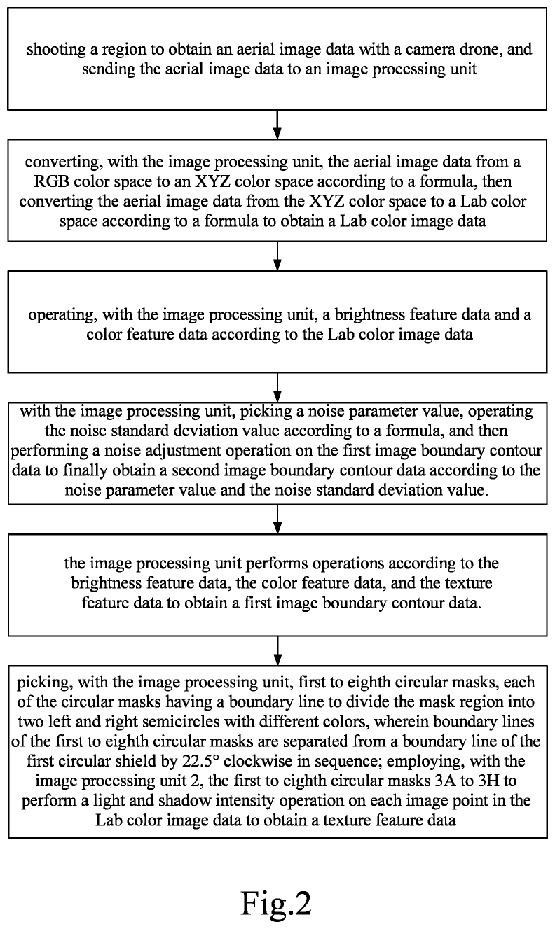

with reference to FIGS. 1 and 2, the image processing unit 2 is communicatively connected to the camera drone 1 for receiving the aerial image data shot by the camera drone 1; the image processing unit 2 is configured to convert the aerial image data from a RGB color space to an XYZ color space according to a formula

$$[ \begin{matrix}X \\ Y \\ Z\end{matrix} ] = [ \begin{matrix}0.4124 & 0.3575 & 0.1804 \\ 0.2126 & 0.7151 & 0.0 \; 721 \\ 0.0193 & 0.1191 & 0.9502\end{matrix} ] [ \begin{matrix}R \\ G \\ B\end{matrix} ] ,$$

then convert the aerial image data from the XYZ color space to a Lab color space according to a formula:

$$L = \{ \begin{matrix}116 * {( \frac{Y}{{Y}_{n}} )}^{\frac{1}{3}} - 16 , if \frac{Y}{{Y}_{n}} > 0.008856 \\ 9.03 .3 * \frac{Y}{{Y}_{n}} , others\end{matrix} \\ a = 500 * ( f ( \frac{X}{{X}_{n}} ) - f ( \frac{Y}{{Y}_{n}} ) ) b = 200 * ( f ( \frac{Y}{{Y}_{n}} ) - f ( \frac{Z}{{Z}_{n}} ) ) wherein \\ {X}_{n} = 0.9 \; 515 {Y}_{n} = 1.0000 {Z}_{n} = 1.0886 \\ f ( t ) = \{ \begin{matrix}{t}^{\frac{1}{3}} , if t > 0.0 \; 08856 \\ 7.787 * t + \frac{16}{116} , others\end{matrix} ,$$

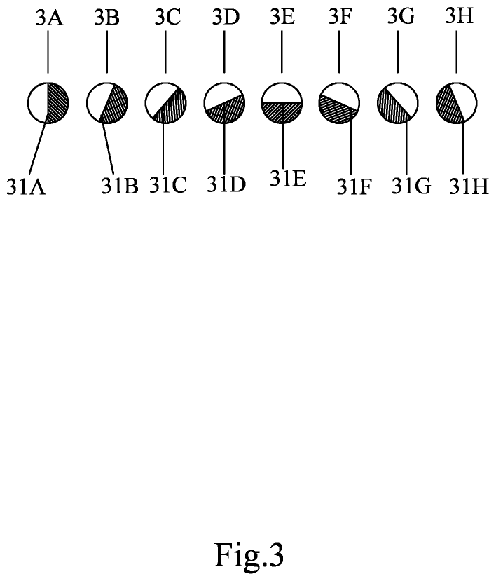

to obtain a Lab color image data, and then operate a brightness feature data and a color feature data according to the Lab color image data. With reference to FIG. 3, the image processing unit 2 picks first to eighth circular masks 3A to 3H, each of the circular masks 3A to 3H having a boundary line 31A to 31H to divide each of the masks 3A to 3H into two left and right semicircles with different colors, wherein boundary lines 31A to 31H of the first to eighth circular masks 3A to 3H are separated from a boundary line 31A of the first circular mask 3A by 22.5° clockwise in sequence.

Next, the image processing unit 2 employs the first to eighth circular masks 3A to 3H to perform a light and shadow intensity operation on each image point in the Lab color image data to obtain a texture feature data. Subsequently, the image processing unit 2 performs operations according to the brightness feature data, the color feature data, and the texture feature data to obtain a first image boundary contour data.

The present invention mainly utilizes 8 circular masks 3A to 3H to perform light and shadow intensity operations on each image point in the Lab color image data, so that the first image boundary contour data has better boundary contour detection and recognition effect. Further, whether the present invention is used for image analysis in terms of multilevel thresholding or binarization, the invention may further improve the overall recognition and detection effect to solve the shortcomings of the background technology.

### Embodiment 2

After the first image boundary contour data is established, in order to highlight an important contour in the image, the present invention may further use the method of noise setting to use the image other than the important contour as the background to highlight the important contour as the foreground; therefore, with reference to FIGS. 1 and 2, the present invention may further be implemented as below: the image processing unit 2 picks a noise parameter value, operates the noise standard deviation value according to

$$Noise Standard Deviation = 5 + 10 ( \frac{1}{1 + {e}^{\frac{- 1 {0}^{*} ( N o i s e P a r a m e t e r - 0.5 )}{2}}} ) ,$$

and then performs a noise adjustment operation on the first image boundary contour data to finally obtain a second image boundary contour data according to the noise parameter value and the noise standard deviation value.

### Embodiment 3

When the present invention is used for automatic grass maintenance, and pruning, the part of the second image boundary contour data that belongs to the grass ground may be recognized, and then the coordinate position may be marked for subsequent automatic grass maintenance, and pruning. To this end, the present invention may be further implemented as below: the camera drone 1 is provided with a first positioning unit 11, and the first positioning unit 11 may be configured to measure latitude and longitude coordinates of the camera drone 1, so that the aerial image data includes a latitude and longitude coordinate data; the second image boundary contour data comprises a grass ground contour block 8; a processing unit 4 finds out a comparison image data on a google map 5 according to the latitude and longitude coordinate data, and the comparison image data corresponds to the second image boundary contour data; the processing unit 4 finds out a latitude and a longitude of the grass ground contour block 8 according to the comparison image data and the second image boundary contour data to obtain a grass ground contour latitude and longitude data.

Since the google map 5 has the latitude and longitude information of each image location, the contour latitude and longitude of the grass ground contour block 8 in the second image boundary contour data may be found in a simplest way through the present invention, so that the lawn may be automatically maintained, and pruned through automated robots.

### Embodiment 4

With reference to FIGS. 1 and 2, the device is further provided with a lawn mower 6, the lawn mower 6 is communicatively connected to the processing unit 4, the lawn mower 6 is provided with a second positioning unit 61, the second positioning unit 61 may be configured to be communicatively connected to a virtual base station real-time kinematic 7 (VBS-TRK) for acquiring a dynamic latitude and longitude coordinate data of the lawn mower 6; the lawn mower 6 moves according to the dynamic latitude and longitude coordinate data and the grass ground contour latitude and longitude data.

After the above grass ground contour latitude and longitude data is obtained by the present invention, the grass ground contour latitude and longitude data may be used to make the lawn mower 6 automatically perform actions such as mowing within the grass range, and a very accurate positioning effect may be obtained through the virtual base station real-time kinematic 7 during the action, so that the overall positioning error is in the centimeter level, and the overall mowing effect is better.

### Embodiment 5

With reference to FIGS. 1, 2 and 4, the processing unit 4 sets a spiral motion path from the outside to the inside according to the grass ground marker block, and the processing unit 4 finds out a spiral motion path longitude and latitude data of the spiral motion path according to the comparison image data; the lawn mower 6 moves along the spiral motion path according to the dynamic latitude and longitude coordinate data and the spiral motion path longitude and latitude data.

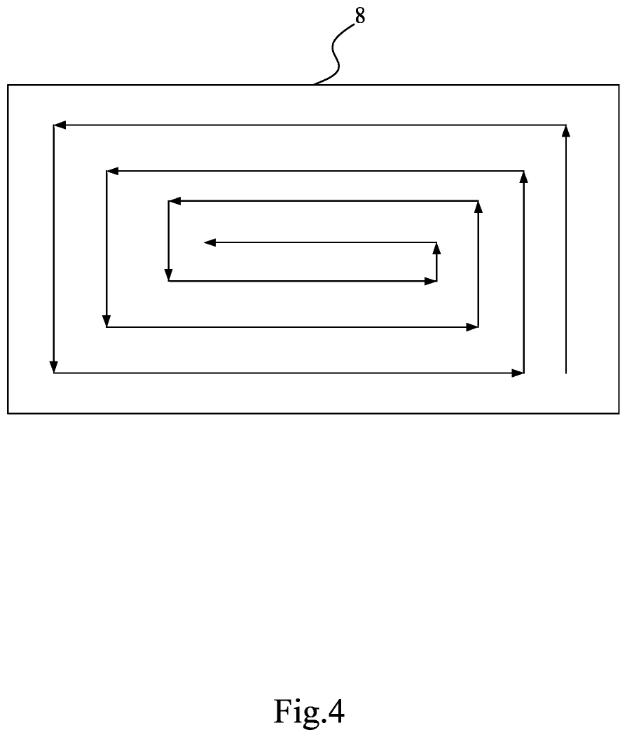

With reference to FIG. 4, the lawn mower 6 starts mowing grass from the outermost contour in the grass ground marker block, and may effectively mow all the grass in the grass ground marker block without being easily missed with the spiral motion from the outside to the inside; at the same time, with the spiral motion mode, in addition to having the best mowing effect, the time required for mowing may be reduced to improve the overall mowing effect and efficiency as compared to the irregular mowing ways. The arrow in FIG. 4 indicates the spiral motion path.

According to Article 31 of the Patent Law, the specification also proposes a boundary detection method; since the advantages and characteristics related description of the boundary detection method are similar to the foregoing boundary detection device, the following description only introduces the boundary detection method, and the description of the related advantages and characteristics will not be repeated. The boundary detection method includes steps of:

(1) shooting a region to obtain an aerial image data with a camera drone 1, and sending the aerial image data to an image processing unit 2;

(2) converting, with the image processing unit 2, the aerial image data from a RGB color space to an XYZ color space according to a formula

$$[ \begin{matrix}X \\ Y \\ Z\end{matrix} ] = [ \begin{matrix}0.4124 & 0.3575 & 0.1804 \\ 0.2126 & 0.7151 & 0.0 \; 721 \\ 0.0193 & 0.1191 & 0.9502\end{matrix} ] [ \begin{matrix}R \\ G \\ B\end{matrix} ] ,$$

then convert the aerial image data from the XYZ color space to a Lab color space according to a formula:

$$L = \{ \begin{matrix}116 * {( \frac{Y}{{Y}_{n}} )}^{\frac{1}{3}} - 16 , if \frac{Y}{{Y}_{n}} > 0.008856 \\ 9.03 .3 * \frac{Y}{{Y}_{n}} , others\end{matrix} \\ a = 500 * ( f ( \frac{X}{{X}_{n}} ) - f ( \frac{Y}{{Y}_{n}} ) ) b = 200 * ( f ( \frac{Y}{{Y}_{n}} ) - f ( \frac{Z}{{Z}_{n}} ) ) wherein \\ {X}_{n} = 0.9 \; 515 {Y}_{n} = 1.0000 {Z}_{n} = 1.0886 \\ f ( t ) = \{ \begin{matrix}{t}^{\frac{1}{3}} , if t > 0.0 \; 08856 \\ 7.787 * t + \frac{16}{116} , others\end{matrix} ;$$

(3) operating, with the image processing unit 2, a brightness feature data and a color feature data according to the Lab color image data;

(4) picking, with the image processing unit 2, first to eighth circular masks 3A to 3H, each of the circular masks 3A to 3H having a boundary line 31A to 31H to divide each of the circular masks 3A to 3H into two left and right semicircles with different colors, wherein boundary lines 31A to 31H of the first to eighth circular masks 3A to 3H are separated from a boundary line 31A of the first circular mask 3A by 22.5° clockwise in sequence; employing, with the image processing unit 2, the first to eighth circular masks 3A to 3H to perform a light and shadow intensity operation on each image point in the Lab color image data to obtain a texture feature data;

(5) performing, with the image processing unit 2, operations according to the brightness feature data, the color feature data, and the texture feature data to obtain a first image boundary contour data.

### Embodiment 1

The step (5) is added with a step (6) of: with the image processing unit 2, picking a noise parameter value, operating the noise standard deviation value according to

$$Noise Standard Deviation = 5 + 10 ( \frac{1}{1 + {e}^{\frac{- 1 {0}^{*} ( N o i s e P a r a m e t e r - 0.5 )}{2}}} ) ,$$

and then performing a noise adjustment operation on the first image boundary contour data to finally obtain a second image boundary contour data according to the noise parameter value and the noise standard deviation value.

### Embodiment 2

In the step (1), the camera drone 1 is provided with a first positioning unit 11, the first positioning unit 11 measures latitude and longitude coordinates of the camera drone 1 while the camera drone 1 is shooting for the aerial image data to comprise a latitude and longitude coordinate data; in the step (5), the first image boundary contour data includes a grass ground contour block 8; the step (6) is added with a step (7) of: with a processing unit 4, finding out a comparison image data on a google map 5 according to the latitude and longitude coordinate data, the comparison image data corresponding to the second image boundary contour data, the processing unit 4 finding out a contour latitude and a longitude of the grass ground contour block 8 according to the comparison image data and the second image boundary contour data to obtain a grass ground contour latitude and longitude data.

### Embodiment 3

The step (7) is further added with a step (8) of: connecting communicatively the lawn mower 6 to the processing unit 4, and providing the lawn mower 6 with a second positioning unit 61, wherein the second positioning unit 61 may be configured to be communicatively connected to a virtual base station real-time kinematic 7 (VBS-TRK) for acquiring a dynamic latitude and longitude coordinate data of the lawn mower 6; the lawn mower 6 moves according to the dynamic latitude and longitude coordinate data and the grass ground contour latitude and longitude data.

### Embodiment 4

Between the step (7) and the step (8), a step (9) of, is further added: with the processing unit 4, setting a spiral motion path from the outside to the inside according to the grass ground marker block, and the processing unit 4 finding out a spiral motion path longitude and latitude data of the spiral motion path according to the comparison image data; in the step (8), the lawn mower 6 moves along the spiral motion path according to the dynamic latitude and longitude coordinate data and the spiral motion path longitude and latitude data.

The above are only preferred embodiments of the invention rather than limits to the invention. Those skilled in the art may make various modifications and changes to the invention. Any modification, equivalent replacement, improvement and the like made within the spirit and principle of the invention all should be included in the protection scope of the invention.

What is claimed is:

1. A boundary detection device, comprising:
a camera drone, for shooting a region to obtain an aerial image data;
an image processing unit, communicatively connected to the camera drone, wherein the image processing unit is configured to convert the aerial image data from a RGB color space to an XYZ color space according to a formula
$$[ \begin{matrix}X \\ Y \\ Z\end{matrix} ] = [ \begin{matrix}0.4124 & 0.3575 & 0.1804 \\ 0.2126 & 0.7151 & 0.0 \; 721 \\ 0.0193 & 0.1191 & 0.9502\end{matrix} ] [ \begin{matrix}R \\ G \\ B\end{matrix} ] ,$$
then convert the aerial image data from the XYZ color space to a Lab color space according to a formula:
$$L = \{ \begin{matrix}116 * {( \frac{Y}{{Y}_{n}} )}^{\frac{1}{3}} - 16 , if \frac{Y}{{Y}_{n}} > 0.008856 \\ 9.03 .3 * \frac{Y}{{Y}_{n}} , others\end{matrix} \\ a = 500 * ( f ( \frac{X}{{X}_{n}} ) - f ( \frac{Y}{{Y}_{n}} ) ) b = 200 * ( f ( \frac{Y}{{Y}_{n}} ) - f ( \frac{Z}{{Z}_{n}} ) ) wherein \\ {X}_{n} = 0.9 \; 515 {Y}_{n} = 1.0000 {Z}_{n} = 1.0886 \\ f ( t ) = \{ \begin{matrix}{t}^{\frac{1}{3}} , if t > 0.0 \; 08856 \\ 7.787 * t + \frac{16}{116} , others\end{matrix}$$
to obtain a Lab color image data, and then operate a brightness feature data and a color feature data according to the Lab color image data; then, the image processing unit picks first to eighth circular masks, each of the circular masks having a boundary line to divide the mask region into two left and right semicircles with different colors, and boundary lines of the first to eighth circular masks are separated from a boundary line of the first circular shield by 22.5° clockwise in sequence;
the image processing unit employs the first to eighth circular masks to perform a light and shadow intensity operation on each image point in the Lab color image data to obtain a texture feature data; and
the image processing unit performs operations according to the brightness feature data, the color feature data, and the texture feature data to obtain a first image boundary contour data.

2. The boundary detection device according to claim 1, wherein the image processing unit picks a noise parameter value, operates the noise standard deviation value according to
$$Noise Standard Deviation = 5 + 10 ( \frac{1}{1 + {e}^{\frac{- 1 {0}^{*} ( N o i s e P a r a m e t e r - 0.5 )}{2}}} ) ,$$
and then performs a noise adjustment operation on the first image boundary contour data to finally obtain a second image boundary contour data according to the noise parameter value and the noise standard deviation value.

3. The boundary detection device according to claim 2, wherein the camera drone is provided with a first positioning unit, the first positioning unit may be configured to measure latitude and longitude coordinates of the camera drone, and the aerial image data comprises a latitude and longitude coordinate data; the second image boundary contour data comprises a grass ground contour block; a processing unit finds out a comparison image data on a google map according to the latitude and longitude coordinate data, and the comparison image data corresponds to the second image boundary contour data; the processing unit finds out a latitude and a longitude of the grass ground contour block according to the comparison image data and the second image boundary contour data to obtain a grass ground contour latitude and longitude data.

4. The boundary detection device according to claim 3, wherein the device is further provided with a lawn mower, the lawn mower is communicatively connected to the processing unit, the lawn mower is provided with a second positioning unit, the second positioning unit may be configured to be communicatively connected to a virtual base station real-time kinematic (VBS-TRK) for acquiring a dynamic latitude and longitude coordinate data of the lawn mower; the lawn mower moves according to the dynamic latitude and longitude coordinate data and the grass ground contour latitude and longitude data.

5. The boundary detection device according to claim 3, wherein the processing unit sets a spiral motion path from the outside to the inside according to the grass ground marker block, and the processing unit finds out a spiral motion path longitude and latitude data of the spiral motion path according to the comparison image data; the lawn mower moves along the spiral motion path according to the dynamic latitude and longitude coordinate data and the spiral motion path longitude and latitude data.

6. A boundary detection method, comprising steps of:
(1) shooting a region to obtain an aerial image data with a camera drone, and sending the aerial image data to an image processing unit;
(2) converting, with the image processing unit, the aerial image data from a RGB color space to an XYZ color space according to a formula
$$[ \begin{matrix}X \\ Y \\ Z\end{matrix} ] = [ \begin{matrix}0.4124 & 0.3575 & 0.1804 \\ 0.2126 & 0.7151 & 0.0 \; 721 \\ 0.0193 & 0.1191 & 0.9502\end{matrix} ] [ \begin{matrix}R \\ G \\ B\end{matrix} ] ,$$
then convert the aerial image data from the XYZ color space to a Lab color space according to a formula:
$$L = \{ \begin{matrix}116 * {( \frac{Y}{{Y}_{n}} )}^{\frac{1}{3}} - 16 , if \frac{Y}{{Y}_{n}} > 0.008856 \\ 9.03 .3 * \frac{Y}{{Y}_{n}} , others\end{matrix} \\ a = 500 * ( f ( \frac{X}{{X}_{n}} ) - f ( \frac{Y}{{Y}_{n}} ) ) b = 200 * ( f ( \frac{Y}{{Y}_{n}} ) - f ( \frac{Z}{{Z}_{n}} ) ) wherein \\ {X}_{n} = 0.9 \; 515 {Y}_{n} = 1.0000 {Z}_{n} = 1.0886 \\ f ( t ) = \{ \begin{matrix}{t}^{\frac{1}{3}} , if t > 0.0 \; 08856 \\ 7.787 * t + \frac{16}{116} , others\end{matrix} ;$$
(3) operating, with the image processing unit, a brightness feature data and a color feature data according to the Lab color image data;
(4) picking, with the image processing unit, first to eighth circular masks, each of the circular masks having a boundary line to divide the mask region into two left and right semicircles with different colors, wherein boundary lines of the first to eighth circular masks are separated from a boundary line of the first circular shield by 22.5° clockwise in sequence; employing, with the image processing unit, the first to eighth circular masks to perform a light and shadow intensity operation on each image point in the Lab color image data to obtain a texture feature data; and
(5) performing, with the image processing unit, operations according to the brightness feature data, the color feature data, and the texture feature data to obtain a first image boundary contour data.

7. The boundary detection method according to claim 6, wherein the step (5) is added with a step (6) of: with the image processing unit, picking a noise parameter value, operating the noise standard deviation value according to
$$Noise Standard Deviation = 5 + 10 ( \frac{1}{1 + {e}^{\frac{- 1 {0}^{*} ( N o i s e P a r a m e t e r - 0.5 )}{2}}} ) ,$$
and then performing a noise adjustment operation on the first image boundary contour data to finally obtain a second image boundary contour data according to the noise parameter value and the noise standard deviation value.

8. The boundary detection method according to claim 7, wherein in the step (1), the camera drone is provided with a first positioning unit, the first positioning unit measures latitude and longitude coordinates of the camera drone while the camera drone is shooting for the aerial image data to comprise a latitude and longitude coordinate data; in the step (5), the first image boundary contour data comprises a grass ground contour block; the step (6) is added with a step (7) of: with a processing unit, finding out a comparison image data on a google map according to the latitude and longitude coordinate data, the comparison image data corresponding to the second image boundary contour data, the processing unit finding out a contour latitude and a longitude of the grass ground contour block according to the comparison image data and the second image boundary contour data to obtain a grass ground contour latitude and longitude data.

9. The boundary detection method according to claim 8, wherein the step (7) is added with a step (8) of: communicatively connecting the lawn mower to the processing unit, and providing the lawn mower with a second positioning unit, wherein the second positioning unit may be configured to be communicatively connected to a virtual base station real-time kinematic (VBS-TRK) for acquiring a dynamic latitude and longitude coordinate data of the lawn mower; the lawn mower moves according to the dynamic latitude and longitude coordinate data and the grass ground contour latitude and longitude data.

10. The boundary detection method according to claim 9, wherein between the step (7) and the step (8), a step (9) of, is further added: with the processing unit, setting a spiral motion path from the outside to the inside according to the grass ground marker block, and finding out a spiral motion path longitude and latitude data of the spiral motion path according to the comparison image data; in the step (8), the lawn mower moves along the spiral motion path according to the dynamic latitude and longitude coordinate data and the spiral motion path longitude and latitude data.
